(19) United States
(12) Patent Application Publication
(10) Pub. No.: US 2004/0149311 A1
(43) Pub. Date: Aug. 5, 2004

(54) Method for cleaning cookware and tableware with film-forming liquid dishwashing compositions, and compositions therefore

(75) Inventors: Peter Robert Foley, Cincinnati, OH (US); Howard David Hutton, Orgeonia, OH (US); Martin Ian James, Pesacara (IT)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/704,887

(22) Filed: Nov. 10, 2003

Related U.S. Application Data
(60) Provisional application No. 60/426,547, filed on Nov. 15, 2002.

(51) Int. Cl. B08B 7/00; C11D 1/00; B08B 9/20

(52) U.S. Cl. 134/4; 134/25.2; 510/218; 510/220

(57) ABSTRACT

A method for cleaning cookware and tableware with film-forming liquid dishwashing compositions is disclosed. The method includes the steps of applying the composition to soiled cookware/tableware, allowing the composition to form a film and act on the soil, and removing the film with the soil, leaving a clean surface. The compositions include a film-forming polymer, a plasticizer, a cleaning active and a carrier.

### CROSS REFERENCE TO RELATED APPLICATIONS

This application claims the benefit of U.S. Provisional Application No. 60/426,547, filed Nov. 15, 2002, which is incorporated by reference herein.

### TECHNICAL FIELD

The present invention is in the field of dishwashing compositions, in particular it relates to methods and compositions suitable for the removal of soils from cookware and tableware.

### BACKGROUND OF THE INVENTION

Dishwashing compositions are well known in the art. The manual dishwashing process requires applying a dishwashing composition directly onto soiled cookware or tableware, or soaking the soiled cookware and tableware in a dishwashing detergent solution, then rubbing of the soil and rinsing the cookware/tableware to remove any soil or detergent residues. Severe types of soil, like for example cooked-, baked-, or burnt-on soils, or soils in narrow cracks or corners of the cookware/tableware are difficult to remove and therefore heavy soiled cookware/tableware requires a tremendous rubbing effort in order to be entirely cleaned. This can be detrimental to the safety and condition of the cookware/tableware. Thus there is still a need for improved cleaning of heavy soiled cookware and tableware, especially when the cookware/tableware contains severe types of soils or soils in narrow cracks or corners, requiring no or minimal rubbing effort and eliminating the need for rinsing, without the risk of damaging the cookware/tableware.

Solutions described in the art provide hard surface cleaning compositions, comprising film-forming polymers. For example, JP2001-26798A describes a detergent composition for cleaning hard surfaces, comprising an enzyme possessing polyphenol oxidization effect, a substrate for said enzyme and a water-soluble macromolecule. The composition is especially used for removing soil that strongly adheres to hard surfaces, like e.g. burnt-on food soils on cookware. The soil is removed by peeling off the film formed by the water-soluble macromolecule. JP-2123197 describes a detergent composition and a cleaning method, using a film-forming resin and a lipophilic water-swelling polymer dissolved or dispersed in an organic solvent, for removing soils in cracks or narrow corners of hard surfaces. The composition is directly applied to the soiled surface and forms a film, due to evaporation of the solvent, while adsorbing the soil. After the film has formed, water is supplied to the film causing it to swell so the film can be easily peeled-off. U.S. Pat. No. 3,994,744 describes a non-scrub cleaning method, using an aqueous cleaning composition having a minimum film-forming temperature of at least 30° C. and comprises a polymer having a glass transition temperature of at least 35° C. and a metal salt. The composition forms a tacky film after being applied to a soiled substrate. Soil adheres to the tacky film, which, as a result of the drying of the composition, fractures to form a removable residue. Other methods using film-forming cleaning compositions are described in JP02-129299, JP-062265 and EP-0185393.

However, there are still some disadvantages with such compositions containing film-forming polymers described in the art. Most importantly, the film properties, especially film strength and elasticity, of some of the films from the prior art are such that the film cannot be easily and entirely removed. The films are brittle and fracture, or require additional steps like e.g. swelling with water in order to be easily peeled-off, or the cookware/tableware requires rinsing or rubbing in order to remove all soil and film residues after the film has been peeled off. Accordingly, it is an object of the invention to provide film-forming liquid dishwashing compositions, which are able to form a strong, elastic and continuous film on soiled cookware/tableware, such that the film can be easily and entirely removed, i.e. leaving no film residues. As such, no or minimal effort is required in order to entirely clean soiled cookware/tableware, even when it is soiled with severe types of soils, eliminating the need for rubbing and rinsing.

Film-forming liquid dishwashing compositions further require certain rheological properties, especially spreading and cling properties, in order to cover the entire surface to be cleaned, but yet must still be easy to apply. Accordingly, it is another object of the invention to provide film-forming liquid dishwashing compositions, which are easy to apply and exhibit suitable rheological properties in order to entirely cover the surface, including narrow cracks and corners, of the cookware/tableware.

It is another object of the invention to provide a method for cleaning cookware and tableware, using film-forming liquid dishwashing compositions.

It is a further advantage of the compositions of the present invention that they do not damage the cookware/tableware and have improved cleaning performance. Indeed, the compositions of the art, which form tacky films or remove soil or dirt from hard surfaces through adherence of the soil to the film, risk damaging the surface of the hard surface, nor are these always satisfactory in removing severe types of soils.

Furthermore, dishwashing compositions, especially those effective for the removal of severe types of soils, like e.g. cooked-, baked-, or burnt-on soils, can contain chemicals that in certain circumstances can affect the user's skin. These compositions are also sometimes perceived as having an unpleasant odor. It is a further advantage of the compositions of the present invention that they are effective for the removal of cooked-, baked-, or burnt-on soils, while minimizing or avoiding contact between the user's skin and the cleaning chemicals and reducing the malodor impression, as the film forms a barrier. These problems are even further reduced, as the compositions of the present invention remain very effective even when low levels of cleaning active are used.

The compositions of the present invention are also very useful as pre-treatment of soiled cookware/tableware, prior to dishwashing.

### SUMMARY OF THE INVENTION

According to a first aspect of the present invention, there is provided a method for cleaning cookware and tableware, characterized in that the method comprises the steps of

a) applying a film-forming liquid dishwashing composition to soiled cookware and tableware, the composition comprising a film-forming polymer, a plasticizer, a cleaning active and a carrier,

b) leaving the applied composition for a sufficient period of time to allow formation of a film and to allow the cleaning active to act on the soil so that the soil is being suspended, dissolved or dispersed in the film-forming composition, and

c) peeling off the film containing the soil from the cookware/tableware, leaving a clean surface.

Preferably, the composition is applied via spraying.

According to a second aspect of the present invention, there are provided film-forming liquid dishwashing compositions suitable for use in above method. The compositions comprise a film-forming polymer, a plasticizer, a cleaning active and a carrier, and the cleaning active preferably comprises an organic solvent system, a bleaching agent, an enzyme, or mixtures thereof.

It is a further aspect of the present invention to provide articles of manufacture comprising the film-forming liquid dishwashing composition in a container adapted to spray said composition. Preferably, the article of manufacture further comprises instructions for use.

### DETAILED DESCRIPTION OF THE INVENTION

Method for Cleaning Cookware/Tableware Using a Film-Formable Liquid Dishwashing Composition

According to a first aspect of the present invention, there is provided a method for cleaning cookware and tableware, characterized in that the method comprises the steps of

a) applying a film-forming liquid dishwashing composition to soiled cookware and tableware, the composition comprising a film-forming polymer, a plasticizer, a cleaning active and a carrier,

b) leaving the applied composition for a sufficient period of time to allow formation of a film and to allow the cleaning active to act on the soil so that the soil is being suspended, dissolved or dispersed in the film-forming composition, and

c) peeling off the film containing the soil from the cookware/tableware, leaving a clean surface.

The composition may be applied to the soiled cookware/tableware in any suitable form like liquid, foam or gel and any suitable means of application, such as pouring, brushing, wiping and spraying. In a highly preferred embodiment, the composition is applied to the soiled cookware and tableware via spraying.

Film-Forming Liquid Dishwashing Composition

According to a second aspect of the present invention, there are provided film-forming liquid dishwashing compositions comprising a film-forming polymer, a plasticizer, a cleaning active and a carrier. The cleaning active preferably comprises an organic solvent system, a bleaching agent, an enzyme, or mixtures thereof. The compositions of the present invention are especially useful in direct application to soiled cookware and tableware and are very effective in cleaning heavy soiled cookware/tableware, especially in removing severe types of soil, like cooked-, baked-, or burnt-on soils, and/or removing soils in narrow corners and cracks.

The compositions are preferably applied to the soiled substrates in the form for example of a spray or foam. Once applied, the composition spreads over the surface and inside cracks and narrow corners to form a continuous coverage of the surface. As the carrier evaporates, the film starts to form and the cleaning active acts on the soil by for example hydrating, weakening or breaking down the soil and suspending, dissolving or dispersing the soil in the film-forming matrix. As soon as a strong, continuous and elastic film has formed, the cleaning activity stops. The film, containing the soil, can now be removed by simply peeling-off the film, leaving a clean surface.

Depending on the type of application, i.e. type and level of soil to be removed, and depending on the nature of the film-forming polymer, plasticizer, cleaning active and carrier, the various components of the composition have to be chosen well such that the period for forming a strong, continuous and elastic film, i.e. drying time of the film-forming composition, is sufficient for the cleaning active to act on the soil and allowing the soil to be suspended, dissolved or dispersed in the film-forming matrix. Thus the drying time equals the cleaning activity period. It is desired that compositions tailored for removing high soil levels and severe types of soils have a film-formation period from about 1 to about 12 hours, preferably from about 3 to about 6 hours. Compositions tailored for removing normal soil levels have a film-formation period from about 5 to about 60 minutes, preferably from about 15 to about 30 minutes. Moreover, completion of the film formation (i.e. film or dry appearance) acts as a sign for the consumer that the cleaning task is complete, improving compliance to usage instructions.

The compositions of the invention meet certain rheological and other performance parameters, especially the ability to spread over and cling to surfaces. In a highly preferred embodiment, the composition has the ability to be sprayed. For example, it is desirable that the product sprayed on a vertical stainless steel surface has a flow velocity less than about 1 cm/s, preferably less than about 0.1 cm/s. For this purpose, the product is in the form of a shear thinning fluid having a shear index n (Herschel-Bulkey model) of from about 0 to about 0.8, preferably from about 0.3 to about 0.7, more preferably from about 0.4 to about 0.6. Highly preferred are shear thinning liquids having a shear index of 0.5 or lower. The fluid consistency index, on the other hand, can vary from about 0.1 to about 50 Pa.sⁿ, but is preferably less than about 1 Pa.sⁿ. More preferably, the fluid consistency index is from about 0.20 to about 0.15 Pa.sⁿ. The product preferably has a viscosity from about 0.1 to about 200 Pa s, preferably from about 0.3 to about 20 Pa s as measured with a Brookfield cylinder viscometer (model LVDII) using 10 ml sample, a spindle S-31 and a speed of 3 rpm. Specially useful for use herein are compositions having a viscosity greater than about 1 Pa s, preferably from about 2 Pa s to about 4 Pa s at 6 rpm, lower than about 2 Pa s, preferably from about 0.8 Pa s to about 1.2 Pa s at 30 rpm and lower than about 1 Pa s, preferably from about 0.3 Pa s to about 0.5 Pa s at 60 rpm. Rheology is measured under ambient temperature conditions (25° C.).

Suitable thickening agents include inorganic clays (e.g. laponites, aluminium silicate, bentonite, fumed silica). The preferred clay thickening agent can be either naturally occurring or synthetic. Preferred synthetic clays include the synthetic smectite-type clay sold under the trademark Laponite® by Southern Clay Products, Inc. Particularly useful are gel forming grades such as Laponite RD® and sol forming grades such as Laponite RDS®. Natural occurring clays include some smectite and attapulgite clays. Mixtures of clays and polymeric thickeners are also suitable for use herein. Preferred for use herein are synthetic smectite-type clays such as Laponite® and other synthetic clays having an average platelet size maximum dimension of less than about 100 nm. Laponite® has a layer structure which in dispersion in water, is in the form of disc-shaped crystals of about 1 nm thick and about 25 nm diameter. Small platelet size is valuable herein for providing a good sprayability, stability, rheology and cling properties as well as desirable aesthetic. Preferably, the compositions herein comprise of from about 0.1% to about 5%, preferably of from about 0.5% to about 3% by weight of the total composition of an inorganic clay.

Other types of thickeners, which can be used in this composition include natural gums, such as xanthan gum, locust bean gum, guar gum, and the like; and the cellulosic type thickeners, such as hydroxyethyl and hydroxymethyl cellulose (ETHOCEL® and METHOCEL® available from Dow Chemical). Natural gums seem to influence the size of the droplets when the composition is being sprayed. It has been found that droplets having an average equivalent geometric diameter from about 3 μm to about 10 μm, preferably from about 4 μm to about 7 μm, as measured using a TSI Aerosizer®, help in odor reduction. Preferred natural gum for use herein is xanthan gum. Furthermore, other polymeric thickeners preferably having a molecular weights range of from about 2000 to about 10,000,000 can be used herein.

Preferred herein from the viewpoint of sprayablility, cling, stability, and soil penetration performance, is a mixture of Laponite® and a polymer-type co-thickener, such as natural gum, a cellulosic type thickener, other polymeric thickeners, all as described herein above, and the like. More preferably, the compositions herein comprise of from about 0.1% to about 5%, preferably of from about 0.5% to about 3% by weight of the total composition of an inorganic clay and of from about 0.05% to about 5%, preferably of from about 0.1% to about 3% by weight of the total composition of a polymer-type co-thickener. Highly preferred herein is a mixture of Laponite® and xanthan gum. Additionally, Laponite®/xanthan gum mixtures help the aesthetics of the product.

Film-Forming Polymer

The composition of the present invention comprises a film-forming polymer. Examples of film-forming polymers especially useful in the present invention are polyvinyl alcohols, polyvinyl butyral, polyvinyl pyrrolidones, polyurethanes, polyacrylamides, and acrylic co-polymers. Preferably, the film-forming polymer is a polyvinyl alcohol or polyvinyl butyral, as they offer the best film properties.

In general terms, low levels of film-forming polymer increase the drying time (rate of film formation) and reduce the rheological properties of the composition, especially the cling properties. High levels of film-forming polymer increase viscosity, reduce sprayability and the ability of applying the composition in a uniform matter. Therefore, it is preferred that the film-forming polymer is present in the composition at a level of from about 0.5% to about 40% by weight, more preferably from about 5% to about 10% by weight of the total composition.

Other factors influencing the ability to crystallize and form a film, as well as the film properties, are the type, degree of crystallinity, degree of hydrolysis or cross-linking and molecular weight of the film-forming polymer. Very rigid polymers (like e.g. polyvinyl alcohol) stack on eachother more readily than flexible polymers, to form an ordered crystal, as the carrier evaporates. More order gives more rapid film formation and less film flexibility, while less ordered structures don't form films as readily or as strong, but have more flexibility. However, while very rigid polymers form strong films quickly, the resulting films may be too rigid (not flexible enough), and therefore require a higher level of plasticizer to give the film some ‘plasticity’ or flexibility.

Plasticizer

The composition of the present invention comprises a plasticizer. Plasticizers are known to influence the properties of the film-forming polymer and consequently the properties of the resulting film. The plasticizer replaces some of the secondary valence bonds, which hold the polymer together, by plasticizer-to-polymer bonds (known as salvation), thus aiding movement of the polymer chain segments. Increased plasticizer levels increase film peelability, but also increase drying time as it changes the glass transition temperature of the film-forming polymer. The plasticizer also changes the elastic properties of the film, in particular increased plasticizer levels result in increased elasticity, low levels of plasticizer make resulting films more brittle and therefore more difficult to remove. Therefore it is important to balance the level of plasticizer depending on the type of film-forming polymer used, film properties desired and the type of application of the composition. Most importantly, the level and type of plasticizer and film-forming polymer have to be chosen such that optimum peelability and film strength is achieved. Indeed, it is highly preferred that the obtained films can be easily peeled off, preferably as a single film sheet, leaving no residues, especially not in corners or cracks.

Suitable plasticizers include alcohols, polyhydric alcohols such as glycerol and sorbitol, and glycols and ether glycols such as mono- or diethers of polyalkylene glycol, mono- or diester polyalkylene glycols, polyethylene glycols (typically up to a molecular weight of about 600), glycolates, glycerol, sorbitan esters, esters of citric and tartaric acid, imidazoline derived amphoteric surfactants, lactams, amides, polyamides, quaternary ammonium compounds, esters such as phtalates, adipates, stearates, palmitates, sebacates, or myristates, and combinations thereof. Particularly preferred are ethylene glycol, propylene glycol, glycerine, butyl oleate, diethylene glycol, di-isobutyl adipate and glyceryl triacetate.

The plasticizer is preferably present in the composition of the present invention from about 0.1% to about 10% by weight, more preferably from about 1% to about 5% by weight of the total composition. However, the exact amounts of the polymer and plasticizer will depend to a large extent on the exact nature of polymer and plasticizers utilised and can be readily selected by the skilled person in the art. For example a high molecular weight polymer material will require a greater amount of plasticiser than a low molecular weight polymer.

Cleaning Active

The composition of the present invention comprises a cleaning active, preferably in amount of from about 0.0001% to about 60% by weight. The cleaning active comprises organic solvent system, a bleaching agent, an enzyme, or mixtures thereof.

As described above, the cleaning active acts on the soil by for example hydrating, weakening or breaking down the soil while the film is being formed and aids in suspending, dissolving or dispersing the soil in the film-forming composition. The cleaning action stops once the carrier is entirely evaporated (i.e. the film is entirely formed). The choice of cleaning active will depend on the nature of the cleaning active (the cleaning active can have an influence on film properties and drying time) and type of application, but has to be balanced with appropriate film-forming polymer and plasticizer, in order to achieve suitable film properties and drying time for the composition. In particular, long drying times are desired for removal of severe soils like cooked-, baked-, or burnt-on soils as it allows the cleaning agent to act for a longer time. Short drying times are desired for removal of normal soil levels.

Organic Solvent System

In one embodiment, the cleaning active of the composition herein is an organic solvent system, preferably in an amount of about 1% to about 60%, more preferably from about 1% to about 30%, even more preferably from about 1% to about 10%, most preferably from about 3% to about 7%, by weight of the total composition. The organic solvent system can comprise one or more organic solvents. In general terms, organic solvents for use herein should be selected so as to be compatible with the cookware/tableware. Furthermore, the solvent system should be effective and safe to use having a volatile organic content above 1 mm Hg (and preferably above 0.1 mm Hg) of less than about 50%, preferably less than about 30%, more preferably less than about 10% and even more preferably less than about 4% by weight of the solvent system. Also they should have very mild pleasant odors. The individual organic solvents used herein generally have a boiling point above about 150° C., flash point above about 100° C. and vapor pressure below about 1 mm Hg, preferably below 0.1 mm Hg at 25° C. and atmospheric pressure. In addition, the individual organic solvents preferably have a molar volume of less than about 500, preferably less than about 250, more preferably less than about 200 cm³/mol, these molar volumes being preferred from the viewpoint of providing optimum soil penetration and swelling.

It is a feature of these solvent based compositions of the invention that they display excellent performance in direct application to soiled cookware and tableware, as well as particularly effective in removing soils of a polymerized baked-on nature from metallic substrates.

Solvents that can be used herein include: i) alcohols, such as benzyl alcohol, 1,4-cyclohexanedimethanol, 2-ethyl-1-hexanol, furfuryl alcohol, 1,2-hexanediol and other similar materials; ii) amines, such as alkanolamines (e.g. primary alkanolamines: monoethanolamine, monoisopropanolamine, diethylethanol-amine, ethyl diethanolamine, beta-aminoalkanols; secondary alkanolamines: diethanolamine, diisopropanolamine, 2-(methylamino)ethanol; ternary alkanol-amines: triethanolamine, triisopropanolamine); alkylamines (e.g. primary alkylamines: monomethylamine, monoethylamine, monopropylamine, mono-butylamine, monopentylamine, cyclohexylamine), secondary alkylamines: (dimethylamine), alkylene amines (primary alkylene amines: ethylenediamine, propylenediamine) and other similar materials; iii) esters, such as ethyl lactate, methyl ester, ethyl acetoacetate, ethylene glycol monobutyl ether acetate, diethylene glycol monoethyl ether acetate, diethylene glycol monobutyl ether acetate and other similar materials; iv) glycol ethers, such as ethylene glycol monobutyl ether, diethylene glycol monobutyl ether, ethylene glycol monomethyl ether, ethylene glycol monoethyl ether, diethylene glycol monomethyl ether, diethylene glycol monoethyl ether, propylene glycol butyl ether and other similar materials; v) glycols, such as propylene glycol, diethylene glycol, hexylene glycol (2-methyl-2, 4 pentanediol), triethylene glycol, composition and dipropylene glycol and other similar materials; and mixtures thereof.

In a preferred embodiment, the solvent system preferably comprises a combination of a soil swelling agent and a spreading auxiliary. Without being bound by the theory, it is believed that the soil swelling agent penetrates and hydrates the soils. The spreading auxiliary facilitates the interfacial process between the soil swelling agent and the soil and aids swelling of the soil. The soil penetration and swelling is believed to weaken the binding forces between soil and substrate.

Soil swelling agent is a substance or composition effective in swelling organic soils, especially cooked-, baked- and burnt-on soils. Preferred soil swelling agents for use herein include organoamine solvents. Suitable organoamine solvents for use as soil swelling agents herein include alkanolamines, alkylamines, alkyleneamines and mixtures thereof. Highly preferred organoamines to be used herein as soil swelling agents comprise alkanolamines, especially monoethanolamine, beta-aminoalkanols, especially methylamine ethanol and 2-amine-2methylpropanol (since it has the lowest molecular weight of any beta-aminoalkanol which has the amine group attached to a tertiary carbon, therefore minimize the reactivity of the amine group) and mixtures thereof.

The soil swelling index (SSI) is a measure of the increased thickness of soil after treatment with a substance or composition in comparison to the soil before treatment with the substance or composition. It is believed, while not being limited by theory that the thickening is caused, at least in part, by hydration or solvation of the soil. Swelling of the soil makes the soil easier to remove with no or minimal application of force, e.g. wiping, rinsing or manual and automatic dishwashing. The measuring of this change of soil thickness gives the SSI. The amount of substance or composition necessary to provide soil swelling functionality will depend upon the nature of the substance or composition and can be determined by routine experimentation. Other conditions effective for soil swelling such as pH, temperature and treatment time can also be determined by routine experimentation. Preferred herein, however are substances and compositions effective in swelling cooked-, baked- or burnt-on soils such as polymerised grease or carbohydrate soils on glass or metal substrates, whereby after the substance or composition has been in contact with the soil for 45 minutes or less, preferably 30 min or less and more preferably 20 min or less at 20° C., the substance or composition has an SSI at 5% aqueous solution and pH of 12.8 of at least about 15%, preferably at least about 20% more preferably at least about 30% and especially at least about 50%. Preferably also the choice of soil swelling agent is such that the final compositions have an SSI measured as neat liquids under the same treatment time and temperature conditions of at least about 100%, preferably at least about 200% and more preferably at least about 500%. Highly preferred soil swelling agents and final compositions herein meet the SSI requirements on polymerized grease soils according to the procedure set out below. SSI is determined herein by optical profilometry, using, for example, a Zygo NewView 5030 Scanning White Light Interferometer. A sample of polymerized grease on a brushed, stainless steel coupon is prepared as described hereinbelow with regard to the measurement of polymerized grease removal index. Optical profilometry is then run on a small droplet of approximately 10 μm thickness of the grease at the edge of the grease sample. The thickness of the soil droplet before (Sᵢ) and after (S_{f}) treatment is measured by image acquisition by means of scanning white light interferometry. The interferometer (Zygo NewView 5030 with 20× Mirau objective) splits incoming light into a beam that goes to an internal reference surface and a beam that goes to the sample. After reflection, the beams recombine inside the interferometer, undergo constructive and destructive interference, and produce a light and dark fringe pattern. The data are recorded using a CCD (charged coupled device) camera and processed by the software of the interferometer using Frequency Domain Analysis. The dimensions of the image obtained (in pixels) are then converted in real dimensions (μm or mm). After the thickness of the soil (Sᵢ) on the coupon has been measured the coupon is soaked in the invention composition at ambient temperature for a given length of time and the thickness of the soil (S_{f}) is measured repeating the procedure set out above. If necessary, the procedure is replicated over a sufficient member of droplets and samples to provide statistical significance. The SSI is calculated in the following manner: SSI=[(S_{f}−Sᵢ)/Sᵢ]×100

In a preferred embodiment herein, the compositions herein may comprise up to about 10%, preferably of from about 2% to about 8%, more preferably of from about 3% to about 7% and most preferably of from about 4% to about 6% by weight of the total composition of a soil swelling agent.

Spreading auxiliary is a substance or composition having surface tension lowering properties. The function of the spreading auxiliary is to reduce the interfacial tension between the soil swelling agent and soil, thereby increasing the wettability of soils by the soil swelling agents. The spreading auxiliary when added to the compositions herein containing soil swelling agents leads to a lowering in the surface tension of the compositions, preferred spreading auxiliaries being those which lower the surface tension below that of the auxiliary itself. Especially useful are spreading auxiliaries able to render a surface tension below about 26 mN/m, preferably below about 24.5 mN/m and more preferably below about 24 mN/m, and especially below about 23.5 mN/m and a pH, as measured in a 10% solution in distilled water, of at least 10.5. Surface tensions are measured herein at 25° C.

Spreading auxiliaries for use herein can be selected generally from organic solvents, wetting agents and mixtures thereof. In preferred embodiments the liquid surface tension of the spreading auxiliary is less than about 30 mN/m, preferably less than about 28 mN/m, more preferably less than about 26 mN/m and more preferably less than about 24.5 mN/m. Suitable organic solvents capable of acting as spreading auxiliaries include alcoholic solvents, glycols and glycol derivatives and mixtures thereof. Preferred solvents for use herein as spreading auxiliaries comprise glycols and glycol ethers, especially diethylene glycol monobutyl ether, propylene glycol butyl ether and mixtures thereof. Wetting agents suitable for use as spreading auxiliaries herein are surfactants and include anionic, amphoteric, zwitterionic, nonionic and semi-polar surfactants. Preferred nonionic surfactants include silicone surfactants, such as Silwet copolymers, preferred Silwet copolymers include Silwet L-8610, Silwet L-8600, Silwet L-77, Silwet L-7657, Silwet L-7650, Silwet L-7607, Silwet L-7604, Silwet L-7600, Silwet L-7280 and mixtures thereof. Preferred for use herein is Silwet L-77. Other suitable wetting agents include organoamine surfactants, for example amine oxide surfactants. Preferably, the amine oxide contains an average of from 12 to 18 carbon atoms in the alkyl moiety, highly preferred herein being dodecyl dimethyl amine oxide, tetradecyl dimethyl amine oxide, hexadecyl dimethyl amine oxide and mixtures thereof.

In highly preferred compositions of the present invention, the organic solvent system comprises organoamine (especially alkanolamine) solvent and glycol ether solvent, preferably in a weight ratio of from about 3:1 to about 1:3, and wherein the glycol ether solvent is selected from ethylene glycol monobutyl ether, diethylene glycol monobutyl ether, ethylene glycol monomethyl ether, ethylene glycol monoethyl ether, propylene glycol monobutyl ether, di- and tri-propylene glycol alkyl ethers, ethylene glycol phenyl ether, and mixtures thereof. In a highly preferred composition the glycol ether is a mixture of diethylene glycol monobutyl ether and propylene glycol butyl ether, preferably in a weight ratio of from about 1:2 to about 2:1.

Also suitable as organic solvent system for use herein are C₁-C₆ alkyl esters of C₆-C₁₈ fatty acids, preferably present in an amount of about 1% to about 60%, more preferably from about 10% to about 30% by weigth of the composition.

The compositions can also comprise organic solvents having a carrier or diluent function (as opposed to soil swelling or spreading) or some other specialized function.

Bleaching Agent

In one embodiment, the cleaning active of the composition herein is a bleaching agent, preferably present in an amount of about 0.01% to about 10%, preferably from about 0.1% to about 5%, most preferably from about 1% to about 3%, by weight of the total composition. Bleaching agents suitable herein include organic bleaches like hydrogen peroxide, alkyl and acyl peracids, alkyl and acyl peroxides; chlorine and oxygen bleaches, especially inorganic perhydrate salts such as sodium perborate mono- and tetrahydrates and sodium percarbonate optionally coated to provide controlled rate of release (see, for example, GB-A-1466799 on sulfate/carbonate coatings), preformed organic peroxyacids and mixtures thereof with organic peroxyacid bleach precursors and/or transition metal-containing bleach catalysts (especially manganese or cobalt). Peroxyacid bleach precursors preferred for use herein include precursors of perbenzoic acid and substituted perbenzoic acid; cationic peroxyacid precursors; peracetic acid precursors such as TAED, sodium acetoxybenzene sulfonate and pentaacetylglucose; pernonanoic acid precursors such as sodium 3,5,5-trimethylhexanoyloxybenzene sulfonate (iso-NOBS) and sodium nonanoyloxybenzene sulfonate (NOBS); amide substituted alkyl peroxyacid precursors (EP-A-0170386); and benzoxazin peroxyacid precursors (EP-A-0332294 and EP-A-0482807). Bleach catalysts preferred for use herein include the manganese triazacyclononane and related complexes (US-A-4246612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). Most preferred bleaching agents as cleaning actives in the compositions of the present invention, are phtalimido amino peroxy caproic acid (PAP), azodinitriles (AIBN) and benzoylperoxide.

Enzyme

In one embodiment, the cleaning active of the composition herein is an enzyme.

Enzymes suitable herein include bacterial and fungal cellulases such as Carezyme® and Celluzyme® (Novozymes); peroxidases; lipases such as Amano-P® (Amano Pharmaceutical Co.), Lipolase®, Lipolase Ultra®, Lipoprime® and Lipex® (Novozymes); cutinases; esterases; proteases such as Esperase®, Alcalase®, Savinase®, Everlase® and Kannase® (Novozymes), Properase® and Purafect Ox® (Genencor), modified bacterial serine proteases, such as those described in EP 251446 (particularly pages 17, 24 and 98), referred to as “Protease B”, and in EP 199404 which refers to a modified enzyme referred to as “Protease A”. Also suitable is the enzyme called “Protease C”, which is a variant of an alkaline serine protease from Bacillus (WO 91/06637). A preferred protease referred to as “Protease D” is a carbonyl hydrolase variant described in WO95/10591 and WO95/10592. Preferred proteases are multiply-substituted protease variants comprising a substitution of an amino acid residue at positions corresponding to positions 103 and 76, there is also a substitution of an amino acid residue at one or more amino acid residue positions other than amino acid residue positions corresponding to positions 27, 99, 101, 104, 107, 109, 123, 128, 166, 204, 206, 210, 216, 217, 218, 222, 260, 265 or 274 of Bacillus amyloliquefaciens subtilisin. WO99/20723, WO99/20726, WO99/20727, WO99/20769, WO99/20770 and WO99/20771 describe also suitable proteases, wherein preferred variants have the amino acid substitution set 101/103/104/159/232/236/245/248/252, more preferably 101G/103A/1041/159D/232V/236H/245R/248D/252K according to the BPN′ numbering. Also suitable is protease BLAP® described in WO91/027292 and their variants described in e.g. WO 95/23221, DE 19857543; alpha and beta amylases such as Purafect Ox Am® and Purastar® (Genencor) and Termamyl®, Ban®, Fungamyl®, Duramyl®, and Natalase® (Novozymes); mannanases such as Mannaway® (Novozymes); pectin degrading enzymes and mixtures thereof. Enzymes are preferably added herein as liquids or solids (like prills, granulates, or cogranulates), at levels typically in the range from about 0.0001% to about 1% pure enzyme by weight of composition.

Carrier

The compositions of the present invention are formulated as liquid compositions, and therefore comprise a carrier. Liquid dishwashing compositions can contain water, low volatile solvents and mixtures thereof as carriers. Low quantities of low molecular weight primary or secondary alcohols such as methanol, ethanol, propanol and isopropanol, as well as low molecular weight ethers, ketones and esters, and mixtures thereof, can be used in the compositions of the present invention.

A preferred composition herein is an aqueous composition and therefore, preferably comprises water. The composition preferably has a pH of more than about 7, more preferably more than about 8. When the cleaning active is an organic solvent system, the pH is more than about 10, preferably more than about 12.

The carrier can be used to control the drying time of the composition. Indeed, the more volatile the carrier, and the more of it (versus water), the faster the drying time.

Optional Ingredients

Pigment/Colorants

The films formed by the composition of the present invention are generally transparent or translucent. In order to make the film clearly visible, especially the edges, and to allow a user to assure that the film is entirely removed, a pigment, colorant or dye may be added to the composition.

Perfume Ingredient

A select combination of perfume materials as defined herein can be incorporated into the compositions of the invention to effectively reduce the intensity of or mask any malodors associated with the use of solvents or bleaching agents in the present compositions. The combination of perfume materials is particularly effective in compositions designated for spray-delivery. In general terms, the odor-masking perfume or perfume base comprises a mixture of volatile and non-volatile perfume materials wherein the level of non-volatile perfume materials (boiling point above 250° C. at 1 atmosphere pressure) is preferably greater than about 20% by weight and preferably lies in the range from about 25% to about 65%, more preferably from about 35% to about 55% by weight. Preferably, the perfume or perfume base comprises at least 0.001% by weight of an ionone or mixture of ionones inclusive of alpha, beta and gamma ionones. Certain flowers (e.g., mimosa, violet, iris) and certain roots (e.g., orris) contain varying levels of ionones that can be used in the perfume formulations herein either in their natural forms or in speciality accords in amounts sufficient to provide the required level of ionones. Preferred ionones are selected from gamma-Methyl lonone, Alvanone extra, Irisia Base, naturally occurring ionone materials obtained, for example, from mimosa, violet, iris and orris, and mixtures thereof. Preferably, the composition herein comprises naturally occurring ionone materials. The perfume or perfume base may additionally comprise a musk. The musk preferably has a boiling point of more than about 250° C. Preferred musks are selected from Exaltolide Total, Habonolide, Galaxolide and mixtures thereof. The masking perfume or perfume base can further comprise a high volatile perfume component or mixture of components having a boiling point of less than about 250° C. Preferred high volatile perfume components are selected from decyl aldehyde, benzaldehyde, cis-3-hexenyl acetate, allyl amyl glycolate, dihydromycenol and mixtures thereof.

The composition can additionally comprise a blooming perfume composition. A blooming perfume composition is one, which comprises blooming perfume ingredients. A blooming perfume ingredient may be characterized by its boiling point and its octanol/water partition coefficient (P). Boiling point as used herein is measured under normal standard pressure of 760 mmHg. The boiling points of many perfume ingredients, at standard 760 mm Hg are given in, e.g., “Perfume and Flavor Chemicals (Aroma Chemicals),” Steffen Arctander, published by the author, 1969. The octanol/water partition coefficient of a perfume ingredient is the ratio between its equilibrium concentrations in octanol and in water. The partition coefficients of the preferred perfume ingredients for use herein may be more conveniently given in the form of their logarithm to the base 10, logP. The logP values of many perfume ingredients have been reported; for example, the Pomona92 database, available from Daylight Chemical Information Systems, Inc. (Daylight CIS), Irvine, Calif., contains many, along with citations to the original literature. However, the logP values are most conveniently calculated by the “CLOGP” program, also available from Daylight CIS. This program also lists experimental logP values when they are available in the Pomona92 database. The “calculated logP” (ClogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990). The fragment approach is based on the chemical structure of each perfume ingredient, and takes into account the numbers and types of atoms, the atom connectivity, and chemical bonding. The ClogP values, which are the most reliable and widely used estimates for this physicochemical property, are preferably used instead of the experimental logP values in the selection of perfume ingredients which are useful herein. The blooming perfume composition herein used comprises one or more perfume ingredients selected from two groups of perfumes. The first perfume group is characterised by having boiling point of 250° C. or less and ClogP of 3.0 or less. More preferably ingredients of the first perfume group have boiling point of 240° C. or less, most preferably 235° C. or less and a ClogP value of 2.5 or less. The first group of perfume ingredients is preferably present at a level of at least about 7.5%, more preferably at least about 15% and most preferably about at least 25% by weight of the blooming perfume composition. The second perfume group is characterised by having boiling point of 250° C. or less and ClogP of greater than 3.0. More preferably ingredients of the second perfume group have boiling point of 240° C. or less, most preferably 235° C. or less and a ClogP value of greater than 3.2. The second perfume group is preferably present at a level of at least about 20%, preferably at least about 35% and most preferably at least about 40% by weight of the blooming perfume composition. The blooming perfume composition comprises at least one perfume from the first group of perfume ingredients and at least one perfume from the second group of perfume ingredients. More preferably the blooming perfume composition comprises a plurality of ingredients chosen from the first group of perfume ingredients and a plurality of ingredients chosen from the second group of perfume ingredients.

In addition to the above, it is also desirable that the blooming perfume composition comprises at least one perfume ingredient selected from either the first and/or second group of perfume ingredients which is present in an amount of at least 7% by weight of the blooming perfume composition, preferably at least 8.5% of the perfume composition, and most preferably, at least 10% of the perfume composition. Preferred compositions for use herein have a weight ratio of the odor masking perfume or perfume base to the blooming perfume from about 10:1 to about 1:10, preferably from about 4:1 to about 1:4 and more preferably from about 3:1 to about 1:2. The overall odor-masking blooming perfume composition preferably comprises from about 0.5% to about 40%, preferably from about 2% to about 35%, more preferably from about 5% to about 30%, more preferably from about 7% to about 20% by weight of the overall composition of ionone or mixtures thereof.

Cyclodextrin

The composition can additionally comprise a cyclodextrin, in order to help control malodor. Cyclodextrins suitable for use herein are those capable of selectively absorbing malodor, causing molecules without detrimentally affecting the odor masking or perfume molecules. Compositions for use herein comprise from about 0.1 to about 3%, preferably from about 0.5 to about 2% of cyclodextrin by weight of the composition. As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in a donut-shaped ring. The specific coupling and conformation of the glucose units give the cyclodextrins a rigid, conical molecular structure with a hollow interior of a specific volume. The “lining” of the internal cavity is formed by hydrogen atoms and glycoside bridging oxygen atoms, therefore this surface is fairly hydrophobic. The unique shape and physical-chemical property of the cavity enable the cyclodextrin molecules to absorb (form inclusion complexes with) organic molecules or parts of organic molecules, which can fit into the cavity. Malodor molecules can fit into the cavity. Preferred cyclodextrins are highly water-soluble such as, alpha-cyclodextrin and derivatives thereof, gamma-cyclodextrin and derivatives thereof, derivatised beta-cyclodextrins, and/or mixtures thereof. The derivatives of cyclodextrin consist mainly of molecules wherein some of the OH groups are converted to OR groups. Cyclodextrin derivatives include, e.g., those with short chain alkyl groups such as methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH₂—CH(OH)—CH₃ or a —CH₂CH₂—OH group; branched cyclodextrins such as maltose-bonded cyclodextrins, cationic cyclodextrins such as those containing 2-hydroxy-3(dimethylamino)propyl ether, wherein R is CH₂—CH(OH)—CH₂—N(CH₃)₂ which is cationic at low pH; quaternary ammonium, e.g., 2-hydroxy-3-(trimethyl-ammonio)propyl ether chloride groups, wherein R is CH₂—CH(OH)—CH₂—N⁺(CH₃)₃Cl⁻; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g. the mono-3-6-anhydrocyclodextrins, as disclosed in “Optimal Performances with Minimal chemical Modification of Cyclodextrins”, F. Diedaini-Pilard and B. Perly, the 7th International Cyclodextrin Symposium Abstracts, April 1994, p. 49, and mixtures thereof. Other cyclodextrin derivatives are disclosed in U.S. Pat. No. 3,426,011, U.S. Pat. No. 3,453,257, U.S. Pat. No. 3,453,258, U.S. Pat. No. 3,453,259, U.S. Pat. No. 3,453,260, U.S. Pat. No. 3,459,731, U.S. Pat. No. 3,553,191, U.S. Pat. No. 3,565,887, U.S. Pat. No. 4,535,152, U.S. Pat. No. 4,616,008, U.S. Pat. No. 4,678,598, U.S. Pat. No. 4,638,058 and U.S. Pat. No. 4,746,734. Highly water-soluble cyclodextrins are those having water solubility of at least about 10 g in 100 ml of water at room temperature, preferably at least about 20 g in 100 ml of water, more preferably at least about 25 g in 100 ml of water at room temperature. Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl beta-cyclodextrin. Hydroxyalkyl cyclodextrin derivatives preferably have a degree of substitution of from about 1 to about 14, more preferably from about 1.5 to about 7, wherein the total number of OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-β-cyclodextrin, commonly known as DIMEB, in which each glucose unit has about 2 methyl groups with a degree of substitution of about 14. A preferred, more commercially available methylated beta-cyclodextrin is a randomly methylated beta-cyclodextrin having a degree of substitution of about 12.6. The preferred cyclodextrins are available, e.g., from American Maize-Products Company and Wacker Chemicals (USA), Inc.

Surfactants and Suds Suppressor

The addition of low level of surfactant selected from anionic, amphoteric, zwitterionic, nonionic and semi-polar surfactants and mixtures thereof, to the composition of the invention aids the cleaning process and also helps to care for the skin of the user. Preferably the level of surfactant is from about 0.05 to about 10%, more preferably from about 0.09 to about 5% and more preferably from 0.1 to 2%. A preferred surfactant for use herein is an amine oxide surfactant.

Surfactants suitable herein include anionic surfactants such as alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀, preferably C₁₀-C₁₈ linear or branched; cationic surfactants such as chlorine esters (U.S. Pat. No. 4,228,042, U.S. Pat. No. 4,239,660 and U.S. Pat. No. 4,260,529) and mono C₆-C₁₆ N-alkyl or alkenyl ammonium surfactants wherein the remaining N positions are substituted by methyl, hydroxyethyl or hydroxypropyl groups; low and high cloud point nonionic surfactants and mixtures thereof including nonionic alkoxylated surfactants (especially ethoxylates derived from C₆-C₁₈ primary alcohols), ethoxylated-propoxylated alcohols (e.g., Olin Corporation's Poly-Tergent® SLF18), epoxy-capped poly(oxyalkylated) alcohols (e.g., Olin Corporation's Poly-Tergent® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC® by the BASF-Wyandotte Corp., Wyandotte, Mich.; amphoteric surfactants such as the C₁₂-C₂₀ alkyl amine oxides (preferred amine oxides for use herein include lauryldimethyl amine oxide and hexadecyl dimethyl amine oxide), and alkyl amphocarboxylic surfactants such as Miranol™ C2M; and zwitterionic surfactants such as the betaines and sultaines; and mixtures thereof. Surfactants suitable herein are disclosed, for example, in U.S. Pat. No. 3,929,678, U.S. Pat. No. 4,259,217, EP-A-0414549, WO-A-93/08876 and WO-A-93/08874. Surfactants are typically present at a level of from about 0.2% to about 30% by weight, more preferably from about 0.5% to about 10% by weight, most preferably from about 1% to about 5% by weight of composition.

Preferred surfactants for use herein are low foaming and include low cloud point nonionic surfactants and mixtures of higher foaming surfactants with low cloud point nonionic surfactants, which act as suds suppresser therefore. “Cloud point”, as used herein, is a well known property of nonionic surfactants which is the result of the surfactant becoming less soluble with increasing temperature, the temperature at which the appearance of a second phase is observable is referred to as the “cloud point” (See Kirk Othmer, pp. 360-362). As used herein, a “low cloud point” nonionic surfactant is defined as a nonionic surfactant system ingredient having a cloud point of less than 30° C., preferably less than about 20° C., and even more preferably less than about 10° C., and most preferably less than about 7.5° C. Typical low cloud point nonionic surfactants include nonionic alkoxylated surfactants, especially ethoxylates derived from primary alcohols, and polyoxypropylene/polyoxyethylene/polyoxypropylene (PO/EO/PO) reverse block polymers. Also, such low cloud point nonionic surfactants include, for example, ethoxylated-propoxylated alcohol (e.g., Olin Corporation's Poly-Tergent® SLF18) and epoxy-capped poly(oxyalkylated) alcohols (e.g., Olin Corporation's Poly-Tergent® SLF18B series of nonionics, as described, for example, in U.S. Pat. No. 5,576,281). Preferred low cloud point surfactants are the ether-capped poly(oxyalkylated) suds suppresser having the formula:

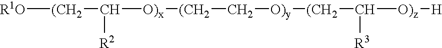

wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25. Other low cloud point nonionic surfactants are the ether-capped poly(oxyalkylated) having the formula:

R_{I}O(R_{II}O)ₙCH(CH₃)OR_{III}

wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:

(i) a 4 to 8 membered substituted, or unsubstituted heterocyclic ring containing from 1 to 3 hetero atoms; and

(ii) linear or branched, saturated or unsaturated, substituted or unsubstituted, cyclic or acyclic, aliphatic or aromatic hydrocarbon radicals having from about 1 to about 30 carbon atoms;

provided that when R_{II} is (ii) then either: (A) at least one of R_{I} is other than C₂ to C₃ alkylene; or (B) R_{II} has from 6 to 30 carbon atoms, and with the further proviso that when R_{II} has from 8 to 18 carbon atoms, R_{III} is other than C₁ to C₅ alkyl.

Other suitable components herein include organic polymers having dispersant, anti-redeposition, soil release or other detergency properties invention in levels of from about 0.1% to about 30%, preferably from about 0.5% to about 15%, most preferably from about 1% to about 10% by weight of composition. Preferred anti-redeposition polymers herein include acrylic acid containing polymers such as Sokalan PA30, PA20, PA15, PA10 and Sokalan CP10 (BASF GmbH), Acusol 45N, 480N, 460N (Rohm and Haas), acrylic acid/maleic acid copolymers such as Sokalan CP5 and acrylic/methacrylic copolymers. Preferred soil release polymers herein include alkyl and hydroxyalkyl celluloses (U.S. Pat. No. 4,000,093), polyoxyethylenes, polyoxypropylenes and copolymers thereof, and nonionic and anionic polymers based on terephthalate esters of ethylene glycol, propylene glycol and mixtures thereof.

Heavy metal sequestrants and crystal growth inhibitors are suitable for use herein in levels generally from about 0.005% to about 20%, preferably from about 0.1% to about 10%, more preferably from about 0.25% to about 7.5% and most preferably from about 0.5% to about 5% by weight of composition, for example diethylenetriamine penta (methylene phosphonate), ethylenediamine tetra(methylene phosphonate) hexamethylenediamine tetra(methylene phosphonate), ethylene diphosphonate, hydroxy-ethylene-1,1-diphosphonate, nitrilotriacetate, ethylenediaminotetracetate, ethylenediamine-N,N′-disuccinate in their salt and free acid forms.

The compositions herein can contain a corrosion inhibitor such as organic silver coating agents in levels of from about 0.05% to about 10%, preferably from about 0.1% to about 5% by weight of composition (especially paraffins such as Winog 70 sold by Wintershall, Salzbergen, Germany), nitrogen-containing corrosion inhibitor compounds (for example benzotriazole and benzimadazole—see GB-A-1137741) and Mn(II) compounds, particularly Mn(II) salts of organic ligands in levels of from about 0.005% to about 5%, preferably from about 0.01% to about 1%, more preferably from about 0.02% to about 0.4% by weight of the composition.

Pre-Treating of Cookware and Tableware

It is an advantage of the compositions and the method of the present invention, that they are very useful as pre-treatment of soiled cookware/tableware, prior to dishwashing. It is a further advantage that the compositions of the present invention, in addition to the method hereinbefore described, can also be used as a normal pre-treatment composition, i.e. applying, preferably spraying the composition to the soiled cookware/tableware, leaving the solution for a sufficient period of time to allow the cleaning active to act on the soil, but not allowing a film to be formed, and wiping or rubbing off the soil, prior to dishwashing.

Article of Manufacture

It is a further aspect of the present invention to provide an article of manufacture comprising a film-forming liquid dishwashing detergent composition as described before, in a container adapted to spray said composition. In a preferred embodiment, the product further comprises instructions for use.

### EXAMPLES

| | composition A | composition B | composition C |
|---|---|---|---|
| Alkyl Dimethyl | 3.0 | — | — |
| Amine Oxide | | | |
| MEA | 5.0 | — | — |
| Glycol Ether (Eph) | 5.0 | — | — |
| Glycol Ether (DPnB) | 5.0 | — | — |
| Benzoyl Peroxide | — | 1.5 | — |
| Natalase | — | — | 0.05 |
| Film-forming Polymer | | | |
| PVA (Mowiol) | 5.0 | 2.0 | 2.0 |
| Plasticizer | | | |
| Glycerol Triacetate | 1.0 | 1.5 | 1.5 |
| Water | balance | balance | balance |

MEA = monoethanolamine
Eph = ethylene glycol phenyl ether
DPnB = dipropylene glycol alkyl ether
PVA = polyvinyl alcohol

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined by the appended claims which should be construed as broadly as the prior art will permit.

What is claimed is:

1. A method for cleaning cookware and tableware, which method comprises the steps of:
a) applying a film-forming liquid dishwashing composition to soiled cookware and tableware, the composition comprising a film-forming polymer, a plasticizer, a cleaning active and a carrier;
b) leaving the applied composition on said soiled cookware and tableware for a sufficient period of time to allow formation of a film and to allow the cleaning active to act on soil on said soiled cookware and tableware so that said soil is suspended, dissolved or dispersed in the film-forming composition; and thereafter
c) peeling off the film containing said soil from the cookware/tableware, leaving a clean surface.

2. A method according to claim 1 wherein the composition is applied to the soiled cookware and tableware via spraying.

3. A method according to claim 1 wherein said method is used for pre-treating cookware and tableware, prior to dishwashing.

4. A method according to claim 1 wherein said film-forming polymer is present at a level from about 0.5% to about 40% by weight of the total composition.

5. A method according to claim 1 wherein said plasticizer is present at a level from about 0.1% to about 10% by weight of the total composition.

6. A method according to claim 1 wherein said cleaning active is present at a level from about 0.0001% to about 60% by weight of the total composition.

7. A method according to claim 1 wherein said film-forming polymer is selected from the group consisting of polyvinyl alcohols, polyvinyl butyral, polyvinyl pyrrolidones, polyurethanes, polyacrylamides and acrylic co-polymers.

8. A method according to claim 1 wherein said plasticizer is selected from the group consisting of ethylene glycol, propylene glycol, glycerine, butyl oleate, diethylene glycol, di-isobutyl adipate and glyceryl triacetate.

9. A method according to claim 1 wherein said cleaning active comprises from about 1% to about 60% by weight of an organic solvent system.

10. A method according to claim 1 wherein said cleaning active is an organic solvent system, said organic solvent system comprising a soil swelling agent and a spreading auxiliary.

11. A method according to claim 1 wherein said cleaning active comprises from about 0.1% to about 10% by weight of a bleaching agent.

12. A method according to claim 1 wherein said cleaning active comprises from about 0.0001% to about 1% by weight of an enzyme.

13. A film-forming liquid dishwashing composition suitable for use in a method for cleaning soiled cookware and tableware employing film-formation, said composition comprising a film-forming polymer, a plasticizer, a cleaning active and a carrier, where said cleaning active comprises an organic solvent system, a bleaching agent, an enzyme, or mixtures thereof.

14. A composition according to claim 13 wherein said film-forming polymer is present at a level from about 0.5% to about 40% by weight of the total composition.

15. A composition according to claim 13 wherein said plasticizer is present at a level from about 0.1% to about 10% by weight of the total composition.

16. A composition according to claim 13 wherein said cleaning active is present at a level from about 0.0001% to about 60% by weight of the total composition.

17. A composition according to claim 13 wherein said film-forming polymer is selected from the group consisting of polyvinyl alcohols, polyvinyl butyrals, polyvinyl pyrrolidones, polyurethanes, polyacrylamides and acrylic co-polymers.

18. A composition according to claim 13, wherein said plasticizer is selected from the group consisting of ethylene glycol, propylene glycol, glycerine, butyl oleate, diethylene glycol, di-isobutyl adipate and glyceryl triacetate.

19. A composition according to claim 13 wherein said cleaning active comprises from about 1% to about 60% by weight of an organic solvent system.

20. A composition according to claim 13 wherein said cleaning active is an organic solvent system, said organic solvent system comprises a soil swelling agent and a spreading auxiliary.

21. A composition according to claim 13 wherein said cleaning active comprises from about 0.1% to about 10% by weight of a bleaching agent.

22. A composition according to claim 13 wherein said cleaning active comprises from about 0.0001% to about 1% by weight of an enzyme.

23. An article of manufacture comprising the composition of claim 13, held in a container adapted to spray said composition.

24. An article of manufacture according to claim 23, further comprising usage instructions for using said composition to clean soiled cookware and tableware.

25. An article of manufacture according to claim 24 wherein said usage instructions specify to apply said composition to soiled cookware and tableware, allow a film to form and peel off said film.

26. An article of manufacture according to claim 24 wherein said usage instructions specify to apply said composition to soiled cookware and tableware, leave the composition on said soiled cookware and tableware for sufficient period of time, and wipe or rub off soil on said soiled cookware and tableware.
